(19) United States
(12) Patent Application Publication
(10) Pub. No.: US 2015/0355215 A1
(43) Pub. Date: Dec. 10, 2015

(54) APPROACH TO ASSESS AVAILABLE WIND RESOURCE DISTRIBUTION BASED ON INTERPOLATION METHOD

(71) Applicants: State Grid Corporation of China, Beijing (CN); Gansu Electric Power Company of State Grid, Lanzhou (CN); Wind Power Technology Center of Gansu Electric Power Company, Lanzhou (CN); Tsinghua University, Beijing (CN)

(72) Inventors: NING-BO WANG, Beijing (CN); LIANG LU, Beijing (CN); YING QIAO, Beijing (CN); ZONG-XIANG LU, Beijing (CN); QING-QUAN LV, Beijing (CN); LONG ZHAO, Beijing (CN)

(21) Appl. No.: 14/515,529

(22) Filed: Oct. 16, 2014

(30) Foreign Application Priority Data
Jun. 5, 2014 (CN) 201410247853.5

(51) Int. Cl. G01P 5/02

(52) U.S. Cl. CPC G01P 5/02

(57) ABSTRACT

An approach to assess available wind resource distribution based on interpolation method includes following steps. A correlation coefficient is obtained between each two of a number of anemometer towers, and a number of first groups are formed by grouping the anemometer towers for the first time with the shortest distance clustering method. A number of second groups are obtained by grouping the plurality of anemometer towers in each of the first groups for the second time, wherein anemometer towers are grouped with absolute value of differences of mean wind velocity between each two of the anemometer towers. A number of values of wind velocity and wind direction at an target point are obtained through at least two anemometer towers in one of the second groups by the inverse distance weighting method, wherein the at least two anemometer towers are nearest to the target point.

### CROSS-REFERENCE TO RELATED APPLICATIONS

This application claims all benefits accruing under 35 U.S.C. §119 from China Patent Application 201410247853.5, filed on Jun. 5, 2014 in the China Intellectual Property Office, the disclosure of which is incorporated herein by reference.

### BACKGROUND

1. Technical Field

The present disclosure relates to an approach to assess available wind resource, especially to an approach to assess available wind resource distribution based on interpolation method.

2. Description of the Related Art

In large-scale wind power grid background, wind power has taken huge challenge to traditional electrical systems in safe and stable operation because of its volatility and randomness. As a basis for various research fields of wind power, performance analysis and modeling of wind resources distribution has become particularly important.

Interpolation model is usually used for meteorological data downscaling, data assimilation and initial field construction. The inverse distance weighting method is most widely used in interpolation model. However, this method relies on the physical similarity and anti-correlation of the distances. Because the impact of external terrain and weather factors on models is ignored, and the introduction of the local topography parameter description is merely considered, the accuracy is limited. Furthermore, the complex sequence features will greatly increase the complexity of the model and has more requirements to the sequence. Thus, statistical models are often difficult to describe the terrain, weather and other factors of the law on the resource characteristics, and fail to character the intrinsic physical principles.

What is needed, therefore, is an approach to assess available wind resource distribution that can overcome the above-described shortcomings.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a flowchart of one embodiment of an approach to assess available wind source distribution based on interpolation method.

FIG. 2 is a flowchart of one embodiment of an approach of calculating wind velocity and wind direction at target point.

FIG. 3 shows a table of one embodiment of a plurality of anemometer towers grouped for a first time.

FIG. 4 shows a table of one embodiment of the plurality of anemometer towers in FIG. 3 grouped for a second time.

FIG. 5 shows a table of one embodiment of mean absolute errors of the wind velocity obtained through the plurality of anemometer towers.

FIG. 6 shows a table of one embodiment of mean absolute errors of the wind direction obtained through the plurality of anemometer towers.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

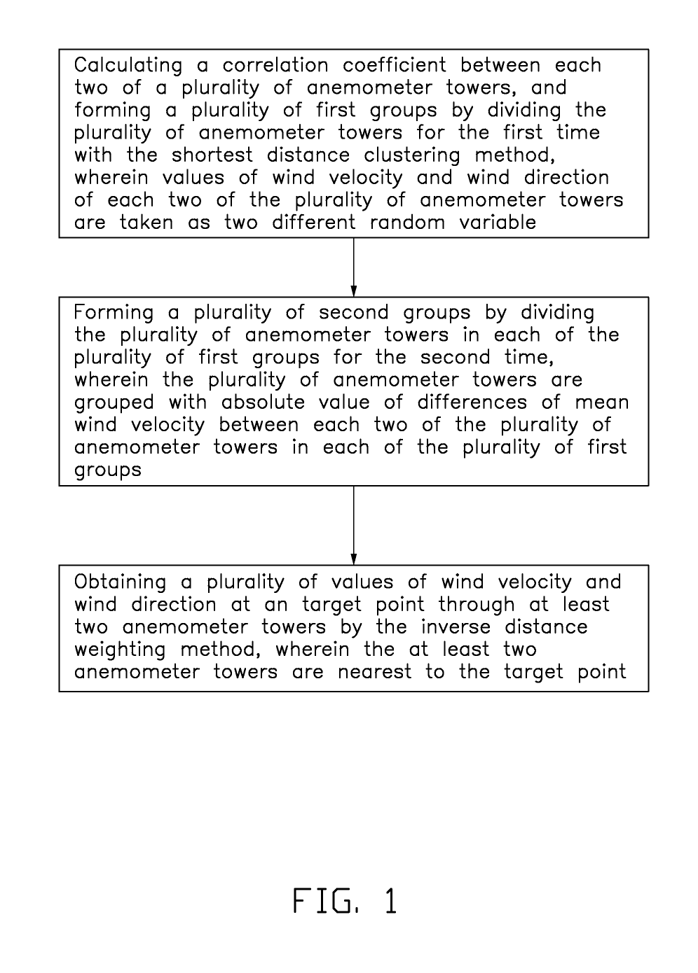

Referring to FIG. 1, an approach to assess available wind resource distribution based on interpolation method comprises following steps:

Step S1, calculating a correlation coefficient between each two of a plurality of anemometer towers, and forming a plurality of first groups by grouping the plurality of anemometer towers for the first time with the shortest distance clustering method, wherein values of wind velocity and wind direction of each two of the plurality of anemometer towers are taken as two different random variables;

Step S2, forming a plurality of second groups by dividing the plurality of anemometer towers in each of the plurality of first groups for the second time, wherein the plurality of anemometer towers are grouped with absolute value of differences of mean wind velocity between each two of the plurality of anemometer towers in each of the plurality of first groups; and

Step S3, obtaining a plurality of values of wind velocity and wind direction at an target point through at least two anemometer towers by the inverse distance weighting method, wherein the at least two anemometer towers are nearest to the target point.

In step S1, the plurality of first groups can be obtained by clustering the plurality of anemometer towers through the plurality of wind velocity data of the plurality of anemometer towers for the past 6 hours.

The shortest distance clustering method belongs to Hierarchy Cluster. The basic principle is to calculate levels of similarity (or distance) based on a certain criterion among different categories. Then two categories that have the highest similarity and recalculate levels of similarity among different categories are combined. The all steps will be redid until the number of categories becomes the same with a set value. The method of clustering with beeline criterion can realize grouping of data, considering it is well-defined and has a very simple model. The specific method of this kind of clustering is shown in followings.

According to the shortest distance clustering method, the distance between two different categories, for example, the distance D_{pq} between and Gₚ and G_{q}, is the minimum value of distance between unit from Gₚ and unit from G_{q}. That is,

$${D}_{pq} = {min}_{{x}_{i} ∈ {G}_{p} , {x}_{j} ∈ {G}_{q}} {d}_{ij} . \qquad ( 1 )$$

Then a distance matrix (m×m) is constructed, in which the number of elements to be clustered is m. After mergering Gₚ and G_{q} between which distance is minimum among the matrix elements except the diagonal matrix elements, a first category Gᵣ can be obtained. Namely, Gᵣ={Gₚ, G_{q}}. In Gᵣ,

dᵣₖ=min{dₚₖ,d_{qk}} (k≠p,q) (2).

Then the distance between the first categories Gᵣ and other categories such as Gₚ and G_{q} is calculated. As a result, a second matrix can be obtained, of which the number of elements is (m−1). Again, the minimum distance dᵢⱼ among the second matrix, merger Gᵢ and Gⱼ is found out, and then the distance between the categories in the second matrix and other categories such as Gᵢ and Gⱼ is calculate. The circulation can be stopped when the number of categories reaches to the set value.

The values of wind velocity and wind direction of two of the plurality of anemometer towers can be taken as two different random variable, such as X and Y. Then the correlation coefficient between X and Y is:

$${r}_{x , y} = \frac{\frac{1}{n} {\sum }_{i = 1}^{n} ( {x}_{i} - {μ}_{x} ) ( {y}_{i} - {μ}_{y} )}{{σ}_{x} {σ}_{y}} , \qquad ( 3 )$$

wherein μₓ is the expected value of X, σₓ is the standard deviation of X, xᵢ is a plurality of individual data in X; μ_{y} is the expected value of Y, σ_{y} is the standard deviation of the Y, yᵢ is a plurality of individual data in Y.

In addition, while grouping the plurality of anemometer towers with correlation coefficients, the minimum distance should correspondent to maximum correlation coefficient. As correlation coefficients reflect the similarity of fluctuation between different values of wind velocity and wind direction, and the anemometer towers with similar fluctuation will be grouped together. If the differences of wind resource are obvious, the number of groups should be added, otherwise the number of groups should be reduced.

In step S2, because the correlation coefficient does not reflect the value relationships between wind velocity, the anemometer towers classified as one group may exist differences in wind velocity values. Thus the plurality of anemometer towers in the first groups need to be grouped for the second time. In addition, because there may be great wind velocity magnitude volatility, the number of groups is not pre-specified here and is judged in the grouping process until the maximum differences between mean wind velocity in the same second group less than a threshold.

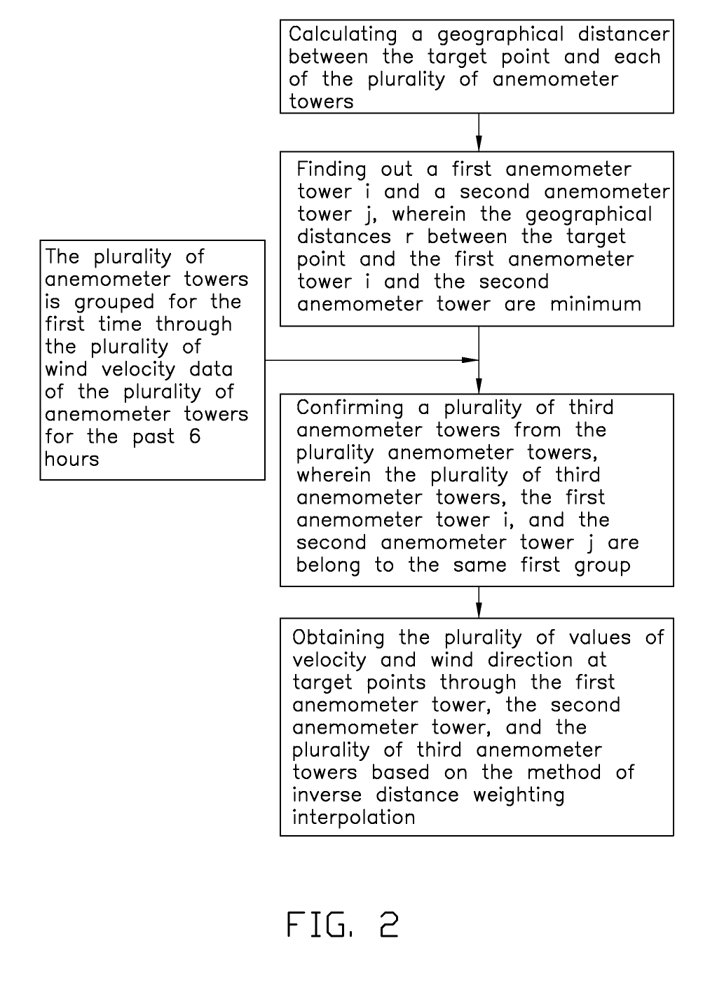

In Step S3, referring to FIG. 2, the plurality of values of wind velocity and wind direction at the target point can be obtained by following substeps:

Step S3.1, calculating a geographical distance r between the target point and each of the plurality of anemometer towers;

Step S3.2, finding out a first anemometer tower i and a second anemometer tower j, wherein the geographical distances r between the target point and the first anemometer tower i and the second anemometer tower j are minimum;

Step S3.3, confirming a plurality of third anemometer towers from the plurality anemometer towers, wherein the plurality of third anemometer towers, the first anemometer tower i, and the second anemometer tower j belong to the same first group;

Step S3.4, obtaining the plurality of values of velocity and wind direction at target points through the first anemometer tower, the second anemometer tower, and the plurality of third anemometer towers based on the method of inverse distance weighting interpolation.

In step S3.1, after finding out the first anemometer tower i, the second anemometer tower j, the plurality of third anemometer towers within the same first group can be obtained based on step S1.

In step S3.2, inverse distance weighted interpolation method need to select an anemometer tower closest to the target point to be estimated as a grouping standard. Furthermore, select only the most recent one anemometer tower could cause instability in results. Thus by selecting the closest two anemometer towers, the calculation accuracy will be improved through the wind velocity and wind direction interpolation consolidated results.

In step S3.4, a weighting function W(r) is set to show the distance from the target point to the known points such as the first anemometer tower, the second anemometer tower, and the plurality of third anemometer towers, and then the values of wind velocity and wind direction through weighting data of the first anemometer tower, the second anemometer tower, and the plurality of third anemometer towers can be obtained.

The W(r) can be set as:

$$\begin{matrix}W ( r ) = \{ \begin{matrix}{[ \frac{{R}^{2} - {r}^{2}}{{R}^{2} + {r}^{2}} ]}^{m} & r \leq R \\ 0 & r > R\end{matrix} & ( 4 ) \\ W ( r ) = 1 / {r}^{2} & ( 5 )\end{matrix}$$

wherein r is the distance between the target point and the known points, R is influence radius which shows the known point has no reference value to the target point if the distance r is larger than R, m is an integer which is larger than 1. Apparently, the closer the distance between the known point to the target point is, the larger the value of weight will be.

In one embodiment, the model is constructed based on the function (5), which shows the closer the distance is, the higher the level of similarity of resources will be. Then a vector interpolation of first wind velocity U in a first direction and a second wind velocity V in a second direction are:

$$\begin{matrix}U = \frac{{\sum }_{i = 1}^{n} ( W ( {r}_{i} ) {U}_{i} )}{{\sum }_{i = 1}^{n} W ( {r}_{i} )} & ( 6 ) \\ V = \frac{{\sum }_{i = 1}^{n} ( W ( {r}_{i} ) {V}_{i} )}{{\sum }_{i = 1}^{n} W ( {r}_{i} )} & ( 7 )\end{matrix}$$

wherein the first direction U are substantially perpendicular to the second direction V. In one embodiment, the first direction U represents the direction from west to the east, and the second direction V represents the direction from south to the north.

The approach to assess available wind resource distribution based on interpolation method has following advantages. First, the shortest distance method is introduced into the approach to assess available wind resource distribution, and the anemometer towers are grouped based on historical actual sequence of real-time packet masts, thus a higher similarity is guaranteed between the fluctuations on the law and values of the packet mast. Second, during performing interpolation calculation, the nearest at least two masts are selected, thus the calculation accuracy is improved through the wind velocity and direction interpolation consolidated results. Third, the accuracy is improved, and the overall level of the model error is limited by the inherently accuracy of such statistical interpolation method.

### Embodiment

The approach to assess available wind resource is applied in the district Jiuquan, GanSu province, China. 22 anemometer towers are selected.

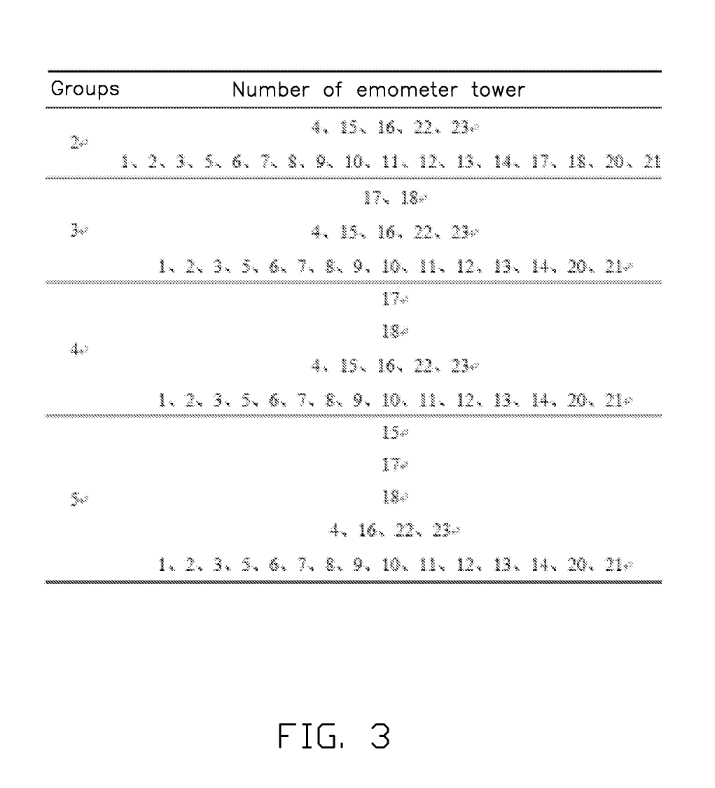

First, referring to FIG. 3, the 22 anemometer towers are grouped for a first time based on the wind velocity and wind direction obtained from Aug. 1, 2011 to Mar. 31, 2012. FIG. 3 shows that no matter how many the groups are obtained, one of the groups has the majority anemometer towers.

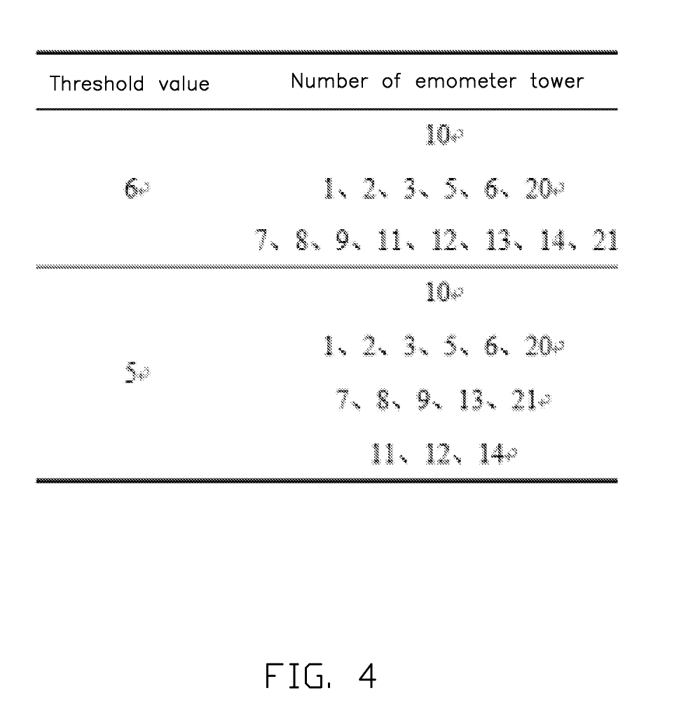

Second, referring to FIG. 4, the group 3 is taken as the example. The group 3 is grouped for a second time base on different threshold values of the wind velocity difference.

Third, the wind velocity and wind direction at the target point is obtained through at least two anemometer towers in the same group after grouped for the second time by the inverse distance weighting method.

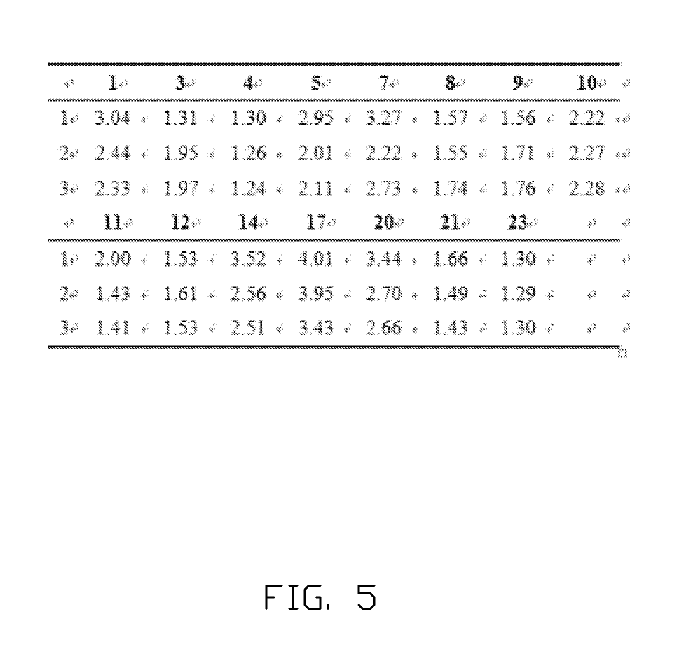

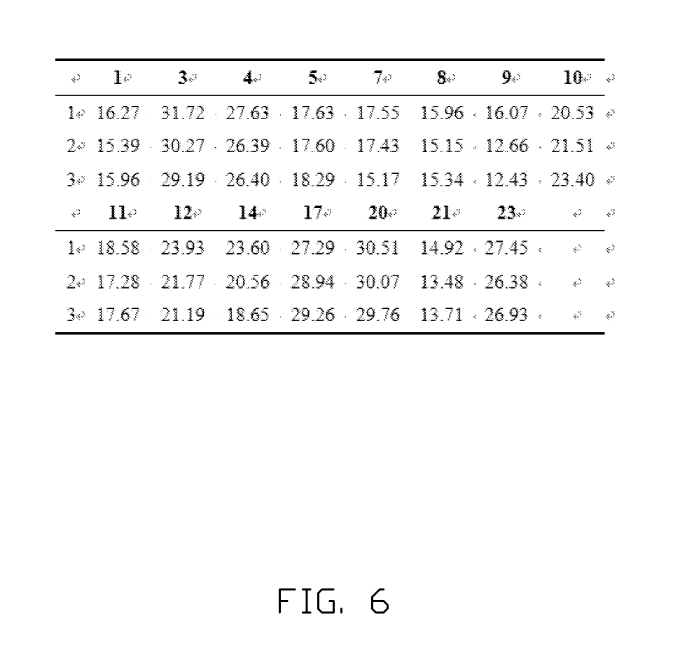

In comparison, one anemometer tower selected to calculate the wind velocity and wind direction is labeled as No. 1. Two anemometer towers in the same group selected to calculate the wind velocity and wind direction is labeled as No. 2. All anemometer towers in the same group selected to calculate the wind velocity and wind direction is labeled as No. 3. Referring to FIG. 5, the mean absolute error of the wind velocity obtained through the anemometer towers in No. 1, No. 2, and No. 3 are listed. Referring to FIG. 6, the mean absolute error of the wind direction obtained through the anemometer towers in No. 1, No. 2, and No. 3 are listed. Because the anemometer towers are grouped for two times, the affect of abnormal wind velocity and wind direction of some anemometer towers is reduced, and the accuracy is improved.

Depending on the embodiment, certain of the steps of methods described may be removed, others may be added, and that order of steps may be altered. It is also to be understood that the description and the claims drawn to a method may include some indication in reference to certain steps. However, the indication used is only to be viewed for identification purposes and not as a suggestion as to an order for the steps.

It is to be understood that the above-described embodiments are intended to illustrate rather than limit the disclosure. Variations may be made to the embodiments without departing from the spirit of the disclosure as claimed. It is understood that any element of any one embodiment is considered to be disclosed to be incorporated with any other embodiment. The above-described embodiments illustrate the scope of the disclosure but do not restrict the scope of the disclosure.

What is claimed is:

1. An approach to assess available wind resource distribution based on interpolation method comprising:
calculating a correlation coefficient between each two of a plurality of anemometer towers, and forming a plurality of first groups by grouping the plurality of anemometer towers for the first time with the shortest distance clustering method, wherein values of wind velocity and wind direction of the two of the plurality of anemometer towers are taken as two different random variable;
forming a plurality of second groups by grouping the plurality of anemometer towers in each of the plurality of first groups for the second time, wherein the plurality of anemometer towers are grouped with absolute value of differences of mean wind velocity between each two of the plurality of anemometer towers; and
obtaining a plurality of values of wind velocity and wind direction at an target point through at least two anemometer towers in one of the plurality of second groups by the inverse distance weighting method, wherein the at least two anemometer towers are nearest to the target point.

2. The approach of claim 1, wherein the plurality of first groups is obtained by clustering the plurality of anemometer towers through the values of the wind velocity and wind direction of the plurality of anemometer towers for the past 6 hours.

3. The approach of claim 1, wherein the plurality of anemometer towers have a similar fluctuation in each of the plurality of first groups.

4. The approach of claim 3, wherein the two different random variables are defined as X and Y respectively, and the correlation coefficient between X and Y is:
$${r}_{x , y} = \frac{\frac{1}{n} {\sum }_{i = 1}^{n} ( {x}_{i} - {μ}_{x} ) ( {y}_{i} - {μ}_{y} )}{{σ}_{x} {σ}_{y}} ,$$
wherein μₓ is an expected value of X, σₓ is a standard deviation of X, xᵢ is a plurality of individual data in X; μ_{y} is a expected value of Y, σ_{y} is a standard deviation of the Y, yᵢ is a plurality of individual data in Y.

5. The approach of claim 1, wherein the plurality of values of wind velocity and wind direction at the target point are obtained by following substeps:
obtaining a geographical distance r between the target point and each of the plurality of anemometer towers;
finding out a first anemometer tower i and a second anemometer tower j, wherein the geographical distances r between the target point and the first anemometer tower i and the second anemometer tower j are minimum;
confirming a plurality of third anemometer towers from the plurality anemometer towers, wherein the plurality of third anemometer towers, the first anemometer tower i, and the second anemometer tower j belong to the same one of the plurality of first groups;
obtaining the plurality of values of velocity and wind direction at target points through the first anemometer tower i, the second anemometer tower j, and the plurality of third anemometer towers based on the inverse distance weighting interpolation.

6. The approach of claim 5, wherein a weighting function W(r) is set to show a weight of a distance from the target point to one of the first anemometer tower, the second anemometer tower, and the plurality of third anemometer towers; and the plurality of values of wind velocity and wind direction at target points are obtained through weighting data of the first anemometer tower, the second anemometer tower, and the plurality of third anemometer towers.

7. The approach of claim 6, wherein the weighting function W(r) is set as:
$$\begin{matrix}W ( r ) = \{ \begin{matrix}{[ \frac{{R}^{2} - {r}^{2}}{{R}^{2} + {r}^{2}} ]}^{m} & r \leq R \\ 0 & r > R\end{matrix} , \\ W ( r ) = 1 / {r}^{2} ,\end{matrix}$$
wherein r is a distance between the target point and the known points, R is influence radius, m is an integer which is larger than 1.

8. The approach of claim 7, wherein the plurality of anemometer towers have reference value to the target point if the distance r is smaller than or equal to R.

9. The approach of claim 8, wherein a first wind velocity U in a first direction is:
$$U = \frac{{\sum }_{i = 1}^{n} ( W ( {r}_{i} ) {U}_{i} )}{{\sum }_{i = 1}^{n} W ( {r}_{i} )} .$$

10. The approach of claim 9, wherein a second wind velocity V in a second direction is:
$$V = \frac{{\sum }_{i = 1}^{n} ( W ( {r}_{i} ) {V}_{i} )}{{\sum }_{i = 1}^{n} W ( {r}_{i} )} ,$$
wherein the first direction U are substantially perpendicular to the second direction V.
